(19) United States
(12) Patent Application Publication
(10) Pub. No.: US 2001/0044008 A1
(43) Pub. Date: Nov. 22, 2001

(54) SERRATED SCREENS FOR FORMING APERTURED THREE-DIMENSIONAL SHEET MATERIALS

(76) Inventors: HUGH JOSEPH O'DONNELL, CINCINNATI, OH (US); YANN-PER LEE, FAIRFIELD, OH (US)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(21) Appl. No.: 09/350,599

(22) Filed: Jul. 9, 1999

(51) Int. Cl. B32B 3/10

(52) U.S. Cl. 428/131

(57) ABSTRACT

The present invention provides a forming structure comprising a screen having a plurality of apertures. The apertures each have a periphery, and each of the apertures has at least one protrusion extending inwardly from the periphery. The protrusions preferably extend inwardly to at least one apex, which may be sharp or have a finite radius. The forming structures may be utilized in a multi-phase forming process to form three-dimensional, macroscopically-expanded apertured film materials.

### FIELD OF THE INVENTION

The present invention relates to forming structures suitable for forming film materials into apertured three-dimensional sheet materials. More specifically, the present invention relates to screens useful for forming multilayer films into apertured three-dimensional sheet materials.

### BACKGROUND OF THE INVENTION

Three-dimensional sheet materials have been developed which include a pattern of microapertures superimposed upon a pattern of macroapertures. These sheet materials are commonly manufactured from a sheet of polymeric film material utilizing a multi-stage process in which a fluid pressure differential is utilized to exert a force on the sheet of film sufficient to rupture the film and form three-dimensional debossments originating in one surface and terminating in corresponding apertures in the opposite surface. Processes of this variety which utilize a stream of pressurized liquid such as water to exert the fluid pressure differential are commonly referred to as “hydroforming” processes. Other means of exerting a fluid pressure differential such as a pressurized gas stream or vacuum may also be employed. Other single-phase forming and aperturing processes wherein only one set of apertures is formed in a film web via hydroforming, vacuum forming, thermoforming, etc., are also frequently employed to produce apertured film webs.

In the multi-stage process, a forming structure such as a metallic screen having a pattern of recesses or apertures is utilized as a supporting member for the film while it is subjected to the fluid pressure differential which accomplishes the controlled rupturing of the film to form a patterned network of apertures. Once the network of apertures is formed, the film is subjected to a fluid pressure differential at least one more time to form a plurality of apertures. The apertures in respective operations may form diverse patterns (with respect to size, spacing, shape, and/or relative position) or may share one or more common attributes.

Sheet materials of the foregoing variety have been employed for various applications including as topsheet materials for use in disposable absorbent articles. These materials and methods and apparatus for making them are described in considerably greater detail in commonly-assigned U.S. Pat. Nos. 4,629,643 and 4,609,518, the disclosures of which are hereby incorporated herein by reference..

More recently, multilayer films have been developed and utilized in such processes to form structures with opposing surfaces which exhibit different hydrophilic properties. For example, a multilayer film may be utilized to fabricate a three-dimensional macroscopically-expanded film web having one surface which exhibits a greater degree of hydrophilicity than the opposite surface. Such webs are described in greater detail in commonly-assigned, co-pending U.S. patent applications Ser. No. 08/837,024, filed Apr. 11, 1997 in the names of Ouellette, et al., and Serial No. [ ], filed Jun. 24, 1999 in the names of Lee et al., entitled “Apertured Webs Having Permanent Hydrophilicity and Absorbent Articles Using Such Webs”, Attorney Docket No. Case 7631, the disclosures of which are hereby incorporated herein by reference.

While such sheet materials have proven useful for a variety of applications, the current formation processes often result in less than ideal performance of the three-dimensional structures in terms of fluid acquisition properties. This is believed to be due to most of the underlying hydrophilic layer being inaccessible to incoming fluid droplets which first contact the upper hydrophobic layer. Fluid droplets thus tend to remain “stranded” upon the hydrophobic surfaces in the upper portion of the larger apertures and are unable to contact the comparatively more hydrophilic material of the lower surface to thus be conducted through the web.

Accordingly, it would be desirable to provide a forming screen which is useful in forming film webs of common compositions into apertured three-dimensional sheet materials which exhibit improved fluid acquisition performance.

It would also be desirable to provide an improved multi-stage process for forming apertured three-dimensional sheet materials which delivers sheet materials exhibiting improved fluid acquisition performance.

### SUMMARY OF THE INVENTION

The present invention provides a forming structure comprising a screen having a plurality of apertures. The apertures each have a periphery, and each of the apertures has at least one protrusion extending inwardly from the periphery. The protrusions preferably extend inwardly to at least one apex, which may be sharp or have a finite radius. The forming structures may be utilized in a multi-phase forming process to form three-dimensional, macroscopically-expanded apertured film materials.

### BRIEF DESCRIPTION OF THE DRAWINGS

While the specification concludes with claims which particularly point out and distinctly claim the present invention, it is believed that the present invention will be better understood from the following description of preferred embodiments, taken in conjunction with the accompanying drawings, in which like reference numerals identify identical elements and wherein:

FIG. 1 is a perspective illustration of a three-dimensional sheet material formed by the process of the present invention;

FIG. 2 is a simplified schematic illustration of a formation process and apparatus in accordance with the present invention;

FIG. 3 is a plan view of one pattern of apertures suitable for use as a forming structure in accordance with the present invention;

FIG. 4 is a plan view of another pattern of apertures suitable for use as a forming structure in accordance with the present invention;

FIG. 5 is a plan view of another embodiment of a pattern of apertures similar to that of FIG. 4 suitable for use as a forming structure in accordance with the present invention;

FIG. 6 is an enlarged view of one embodiment of a protrusion in accordance with the present invention;

FIG. 7 is an enlarged view of another embodiment of a protrusion in accordance with the present invention; and

FIG. 8 is an enlarged view of a further embodiment of a protrusion in accordance with the present invention.

### DETAILED DESCRIPTION OF THE INVENTION

While the present invention will be described in the context of producing three-dimensional sheet materials particularly suited for use in disposable absorbent articles, more particularly in the context of sanitary napkins, the present invention is in no way limited to such applications. To the contrary, the present invention may be practiced to great advantage whenever it is desired to produce three-dimensional sheet materials not previously obtainable using prior art web forming processes.

### Three-Dimensional Sheet Materials

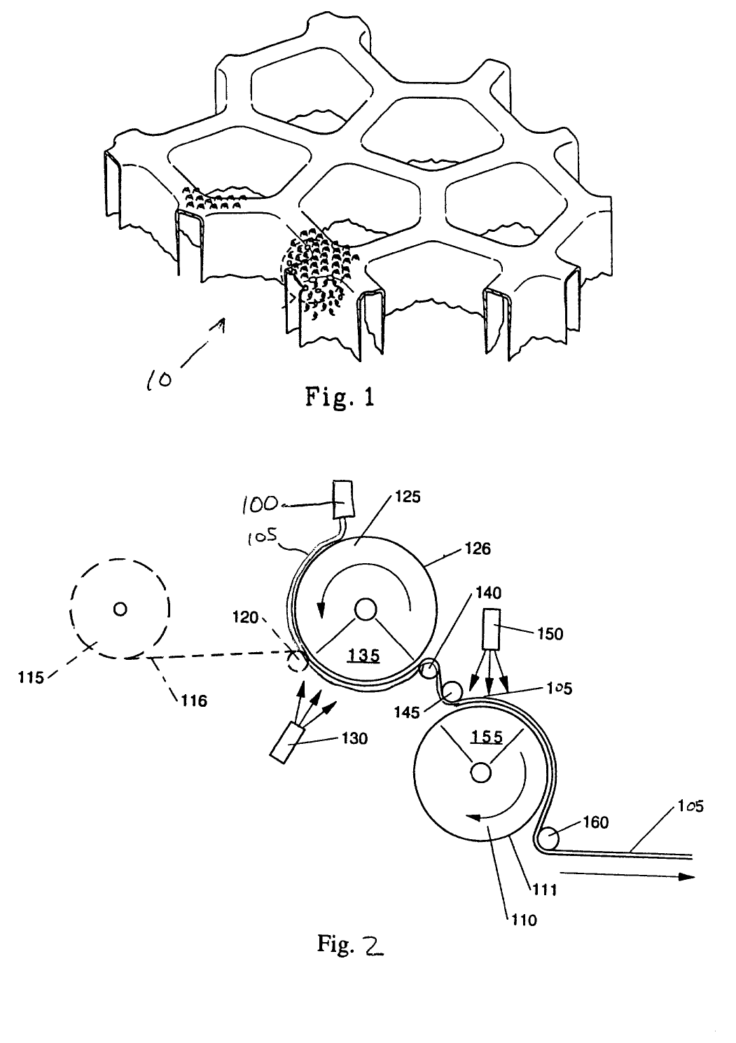

FIG. 1 depicts a representative three-dimensional sheet material of the type described in the aforementioned U.S. Pat. Nos. 4,629,643 and 4,609,518. Sheet material 10 is particularly well suited for use as a topsheet or acquisition layer in a sanitary napkin or other absorbent article. FIG. 1 is an enlarged, partially segmented, perspective illustration of a preferred embodiment of sheet material which has been formed into a macroscopically expanded, three-dimensional, fiber-like, apertured web. The overall form/shape of the macroscopically expanded web 10 is generally in accordance with the teachings of commonly assigned U.S. Pat. No. 4,342,314, issued to Radel et al. on Aug. 3, 1982 and hereby incorporated herein by reference.

The material selected for the sheet material 10 is preferably machinable and capable of being formed into a sheet. Since the sheet material 10 is to be used in consumer products which contact the human body, the material is preferably soft and safe for epidermal or other human contact. Preferred materials for the sheet material are polymeric materials including, but not limited to polyolefins, particularly polyethylenes, polypropylenes and copolymers having at least one olefinic constituent. Other polymeric materials such as polyester, nylon, copolymers thereof and combinations of any of the foregoing may also be suitable.

If desired, conventional amounts of agents may also be added to the polymeric matrix of the sheet material. It is often desired to add agents to increase the opacity of the sheets. Whiteners, such as titanium dioxide and calcium carbonate may be used to opacify the sheet material. It may also be desired to add other agents such as surfactants to impart a hydrophilic nature to the sheet material.

The sheet material may be a monolayer polymeric film or a multilayer polymeric film such as those disclosed in commonly assigned U.S. Pat. No. 5,006,394 issued to Baird on Apr. 9, 1991 and U.S. Pat. No. 5,261,899 issued to Visscher et al. on Nov. 16, 1993, said patents being incorporated herein by reference. Multilayer materials believed to be of particular advantage when utilized with forming structures and methods according to the present invention include those multilayer film materials having hydrophilic and hydrophobic layers disclosed in the aforementioned commonly-assigned, co-pending U.S. Patent Applications referenced and incorporated above.

### Multi-Phase Process for Making Sheet Materials

While the serrated screens of the present invention may be utilized in single-phase forming and aperturing processes wherein only one set of apertures is formed in a film web via hydroforming, vacuum forming, thermoforming, etc., it is believed that the advantages of the present invention are particularly apparent when practiced as part of a multi-phase (i.e., multi-step) forming and aperturing process such as the process described below. Single-phase processes may also be similarly practiced utilizing processing steps similar to portions of the multi-phase process below.

FIG. 2 is a simplified, schematic flow diagram of a process according to the present invention for producing three-dimensional sheet materials, in particular, three-dimensional, macroscopically expanded sheet materials such as the sheet material 10 of FIG. 1. A web of substantially planar film 105 comprised of a polymeric material such as polyethylene is extruded from an extruder 100 onto the surface of forming drum 125 about which a forming structure 126 continuously rotates at substantially the same speed as the incoming web. The web of film is driven by the forming drum 125.

As an alternative to direct extrusion of the polyolefin resin, a web of substantially planar film 116 comprised of a polymeric material such as polyethylene may be fed from supply roll 115 around idler roll 120 and onto the surface of forming drum 125.

Forming structure 126 comprises a microapertured surface which rotates about a stationary vacuum chamber 135, generally in accordance with the teachings of U.S. Pat. Nos. 4,629,643 and 4,609,518, the disclosures of which are hereby incorporated herein by reference. Forming structure 126 is preferably comprised of a plurality of individual photoetched lamina. A high pressure liquid jet nozzle 130 is directed at the surface of the web 105 intermediate a pair of baffles (not shown) as the web traverses the vacuum chamber 135. The high pressure, i.e., preferably at least about 800 psig., jet of liquid causes the web 105 to assume the general contour of the aperture pattern of the forming structure 126. In addition, because the areas of the web 105 spanning the microapertures are unsupported, the fluid jet causes rupture at those portions of web 105 coinciding with the microapertures in the forming structure 126, thereby producing a “microapertured” web. This microapertured web exhibits a multiplicity of fine scale surface aberrations with microapertures coinciding with the point of maximum amplitude of the surface aberrations. The structure and formation of such microapertured webs is described in greater detail in the above-referenced and incorporated U.S. Patents.

After the microaperturing process is completed, the microapertured web is removed from forming structure 126 about an idler roll 140, passed about an idler roll 145, and applied to the outwardly-facing surface of the forming drum 110 about which a forming structure 111 continuously rotates at substantially the same speed as the incoming web. The web of film is driven by the forming drum 110. Alternatively, the forming structures 110 and 125 may be positioned in closer proximity to one another, such that the idler rolls 140 and 145 may be omitted. The microapertured web, when produced by the above-described method, is preferably oriented such that the microscopic surface aberrations are oriented so as to face outwardly away from the forming structure 111. However, if desired for certain applications the microapertured web may be oriented such that the microscopic surface aberrations are oriented so as to face inwardly toward the forming structure

Forming structure 111 comprises a macroapertured surface and is preferably constructed generally in accordance with the teachings of U.S. Pat. No. 4,342,314, issued to Radel and Thompson on Aug. 3, 1982, the disclosure of which is hereby incorporated herein by reference. Forming structure 111 is preferably comprised of a plurality of individual photoetched lamina. Alternatively, forming structures may be formed from suitable materials as a unitary, monolithic structure.

The forming drum 110 preferably includes an internally located vacuum chamber 155 which is preferably stationary relative to the moving forming structure 111. A pair of stationary baffles (not shown) approximately coinciding with the beginning and end of the vacuum chamber 155 are located adjacent the exterior surface of the forming structure. Intermediate the stationary baffles there is preferably provided means for applying a fluid pressure differential to the web 105 as it passes over the vacuum chamber. In the illustrated embodiment, the fluid pressure differential applicator means comprises a high-pressure liquid nozzle 150 which discharges a jet of liquid, such as water, substantially uniformly across the entire width of web 105. Examples of methods for the production of formed materials using a high-pressure liquid stream are disclosed in U.S. Pat. No. 4,695,422, issued to Curro et al. on Sep. 22, 1987; U.S. Pat. No. 4,778,644, issued to Curro et al. on Oct. 18, 1988; and U.S. Pat. No. 4,839,216, issued to Curro et al. on Jun. 13, 1989, the disclosures of all of these patents being hereby incorporated herein by reference.

The water jet causes the web 105 to conform to the forming structure 111 and apertures the web 105 in the areas coinciding with the capillaries in forming structure 111. In some situations, it may be preferable to heat the liquid stream to cause the web to more readily deform. The pressure of the liquid stream is preferably selected so as to achieve sufficient conformity of the web to the forming structure without compromising the integrity of the sheet material itself.

Following application of the fluid pressure differential to the web, the three-dimensional, macroscopically-expanded, apertured laminate web 155 is removed from the surface of the forming structure 111 about an idler roll 160 in the condition shown in FIG. 1. The apertured laminate web 105 may be utilized without further processing as a topsheet in an absorbent article. Alternatively, the apertured laminate web 105 may be subjected to further processing, such as ring rolling, creping, or surface treatment as may be desired.

### Forming Structure Construction

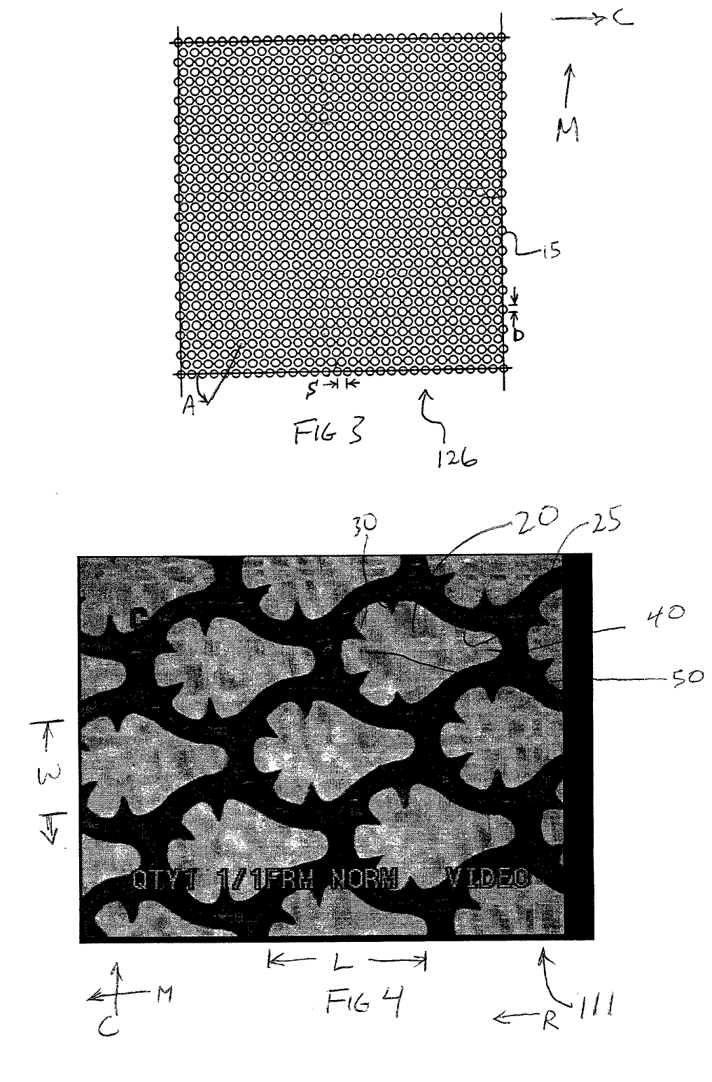

FIG. 3 depicts a forming structure suitable for use as a forming structure 126 in accordance with the method of the present invention. As shown in FIG. 3, the forming structure 126 includes a plurality of microapertures 15 formed into a regular repeating, ordered array-type of pattern. The microapertures 15 are preferably substantially circular in cross section and have a diameter D and a spacing S. For purposes of illustrative clarity, the forming structure 126 depicted in FIG. 3 is shown in a substantially planar orientation to avoid introducing the effects of curvature into the present discussion. However, when employed in the continuous process of the present invention the forming structure depicted in FIG. 3 would be formed into a cylindrical shape (or partial segment thereof) and secured to the surface of a forming drum such as forming drum 125 of FIG. 2. The forming structure has a machine direction M which corresponds to the circumferential direction of the forming drum 125 and a cross direction C which is substantially perpendicular thereto.

The array pattern shown in FIG. 3 is consistent with that of a commercially available screen which may have apertures of a specified diameter and pattern density. As used herein, the term pattern density is used to refer to a number of apertures per unit area, such as apertures per square inch. From the pattern density a center to center spacing S may be calculated in a dominant direction, typically either the machine direction M or the cross direction C. The apertures may be arranged in rows and columns aligned with the respective machine and cross directions or, more frequently, as depicted in FIG. 3 the rows and/or columns may be skewed at an angle A from the machine and/or cross directions. For an orthogonal array pattern the spacing S would be constant in both the machine and cross directions. The pattern of microapertures depicted in FIG. 3 is what is referred to commercially as a 60 degree offset pattern, wherein one dominant direction is cross direction aligned and the other dominant direction is offset at 60 degrees from the machine direction, such that sequential microapertures in the M direction are offset into a staggered pattern but the sequential microapertues in the C direction as aligned.

FIG. 4 depicts a “serrated screen” suitable for use as a forming structure 111 in accordance with the present invention. As shown in FIG. 4, the forming structure 111 includes a plurality of macroapertures 20 formed into a regular repeating, ordered array-type of pattern. The macroapertures 20 have a periphery 25, which is preferably curvilinear but may include linear segments, and have a width W and a length L. The apertures depicted in the embodiment of FIG. 4 exhibit a generally teardrop-shaped configuration. For purposes of illustrative clarity, the forming structure 111 depicted in FIG. 4 is shown in a substantially planar orientation to avoid introducing the effects of curvature into the present discussion. However, when employed in the continuous process of the present invention the forming structure depicted in FIG. 4 would be formed into a cylindrical shape (or partial segment thereof) and secured to the surface of a forming drum such as forming drum 110 of FIG. 2. The forming structure has a machine direction M which corresponds to the circumferential direction of the forming drum 110 and a cross direction C which is substantially perpendicular thereto. FIG. 4 also illustrates a preferred rotation direction R which represents the direction the forming structure would rotate when mounted upon a rotary forming drum as shown in FIG. 2, such that the larger end of the apertures 20 would form the leading edge.

In accordance with the present invention, the screen which comprises forming structure 111 includes within its apertures 20 at least one, and preferably a plurality, of protrusions 30 extending inwardly from the periphery 25. Preferably the protrusions extend inwardly substantially perpendicularly to the portion of the periphery 25 from which they project, although other orientations may be employed. The protrusions are preferably symmetrically arranged with respect to the longitudinal (machine direction) of the macroapertures 20, and may be an even number as shown in FIG. 4 or an odd number if desired. The protrusions are preferably equally spaced and preferably a small integer number such as 2, 4, 7, etc. The protrusions interrupt the otherwise smooth and continuous periphery of the aperture and in effect present a “serrated” edge which engages the film when the film is stripped from the forming structure. Without wishing to be bound by theory, it is believed that the serrations stretch the film to a greater extent than would otherwise occur and in fact cause a slight slitting or tearing of the film adjacent the lower edge of the macroapertures, thereby exposing the underlying more hydrophilic surfaces to incoming fluid. This in turn is believed to provide enhanced fluid acquisition properties, and the mechanical manipulation and modification of the film by the serrations may yield additional tactile benefits such as increased softness. Protrusions may be spaced as desired around the periphery of the aperture, but at a minimum are preferably located in the portion of the aperture which forms the leading edge of the aperture when the forming structure is rotated in the presently preferred rotation direction R as shown in FIGS. 4 and 5. It is presently believed that the benefits of the present invention are best realized when the formed film is first removed from the serrated leading edge of the apertures first versus having the serrated portion at the rear of the apertures from which the film material is removed last.

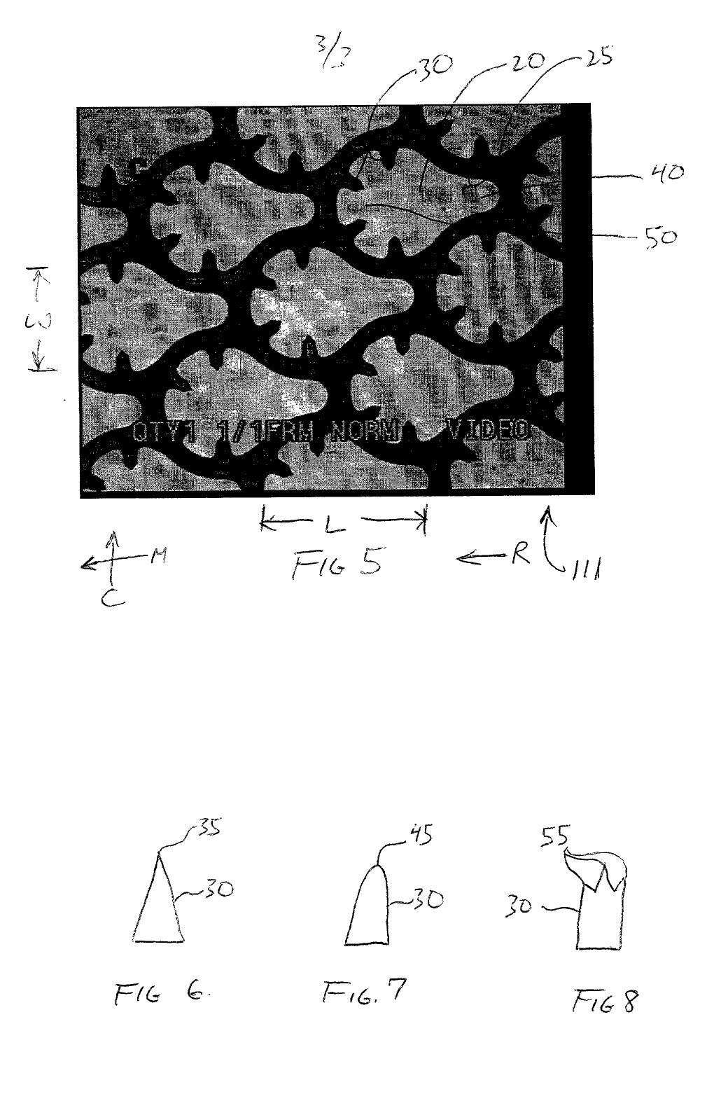

FIG. 5 depicts another embodiment of a screen such as the forming structure 111 of FIG. 4. The embodiment of FIG. 5 differs with regard to the design of the protrusions 30. By way of illustration, FIGS. 6, 7, and 8 illustrate representative protrusion designs suitable for use in accordance with the present invention. In the embodiment of FIG. 6, the protrusion 30 has a generally triangular tapered shape and tapers to a sharp apex 35 having a substantially infinitely small radius of curvature. The protrusion of FIG. 7 has a more rounded profile than that of FIG. 6 and tapers to a rounded apex 45 having a finite radius of curvature. The protrusion of FIG. 8 is less tapered and may have a substantially uniform cross section, but is included primarily to illustrate that a protrusion 30 may in fact have a plurality of apexes 55 which may be sharp apexes or rounded apexes. All protrusions within an aperture may be the same or similar in shape, or different protrusion designs may be employed within a single aperture. Protrusions of any suitable size may be utilized, such as between about 0.003″ and about 0.020″, more preferably between about 0.005″ and about 0.010″.

A plurality of apexes may be obtained by producing the forming structure as one or more layers or lamina having the desired geometry. Alternatively, a plurality of apexes may also be produced utilizing a plurality of lamina by offsetting the stacked lamina such that protrusions on successive lamina are misaligned. This structure creates a three-dimensional plurality of apexes that may effectively modify films into expanded formed sheets. This technique can be expanded to include using protrusions having multiple apexes stacked at vertical offsets. This increases the possible combinations of geometries.

While it is presently preferred in a multi-stage process to utilize a “serrated” screen for the macroaperturing operation, it may be desirable to also utilize such a screen for the initial microaperturing operation as well or as an alternative.

While particular embodiments of the present invention have been illustrated and described, it will be obvious to those skilled in the art that various changes and modifications may be made without departing from the spirit and scope of the invention, and it is intended to cover in the appended claims all such modifications that are within the scope of the invention.

What is claimed is:

1. A forming structure comprising a screen having a plurality of apertures, said apertures each having a periphery, each of said apertures having at least one protrusion extending inwardly from said periphery.

2. The forming structure of claim 1, wherein said protrusion extends inwardly to at least one apex.

3. The forming structure of claim 2, wherein said apex has a finite radius.

4. The forming structure of claim 2, wherein said apex is sharp and has an infinitely small radius.

5. The forming structure of claim 1, wherein said protrusion extends inwardly to a plurality of apexes.

6. The forming structure of claim 1, wherein said apertures include a plurality of protrusions.

7. The forming structure of claim 6, wherein said plurality of protrusions are symmetrically arranged with respect to at least one axis of symmetry.

8. The forming structure of claim 6, wherein said forming structure comprises a plurality of lamina.

9. The forming structure of claim 8, wherein said plurality of lamina are offset.

10. The forming structure of claim 6, wherein said said apertures have a curvilinear periphery.

11. A process for forming a three-dimensional, macroscopically-expanded sheet material from a web of polymeric film material, said process comprising the steps of:
(a) feeding said web onto a first forming structure having opposed surfaces such that a first surface of said web is in contact with said forming structure, said first forming structure exhibiting a multiplicity of microapertures which place the opposed surfaces of said first forming structure in fluid communication with one another;
(b) applying a fluid pressure differential across the thickness of said web, said fluid pressure differential being sufficiently great to cause said web to rupture in those areas coinciding with said microapertures in said first forming structure and to conform with said first forming structure;
(c) feeding said web onto a second forming structure having opposed surfaces, said second forming structure exhibiting a multiplicity of macroapertures which place the opposed surfaces of said second forming structure in fluid communication with one another, said macroapertures each having a periphery, said macroapertures each having at least one protrusion extending inwardly from said periphery; and
(d) applying a fluid pressure differential across the thickness of said web, said fluid pressure differential being sufficiently great to cause said web to rupture in those areas coinciding with said macroapertures in said second forming structure and to conform with said second forming structure.

12. The process of claim 11, wherein said fluid pressure differential comprises a heated high pressure jet of liquid.

13. The process of claim 11, wherein said fluid pressure differential comprises an applied vacuum.

14. The process of claim 11, wherein said macroapertures include a plurality of protrusions.

15. An apertured three-dimensional sheet material, said sheet material being made by the process of claim 11.

16. A process for forming a three-dimensional, macroscopically-expanded sheet material from a web of polymeric film material, said process comprising the steps of:
(a) feeding said web onto a forming structure having opposed surfaces such that a first surface of said web is in contact with said forming structure, said forming structure exhibiting a multiplicity of apertures which place the opposed surfaces of said forming structure in fluid communication with one another, said apertures each having a periphery, said apertures each having at least one protrusion extending inwardly from said periphery;
(b) applying a fluid pressure differential across the thickness of said web, said fluid pressure differential being sufficiently great to cause said web to rupture in those areas coinciding with said apertures in said forming structure and to conform with said forming structure.

17. The process of claim 16, wherein said fluid pressure differential comprises a heated high pressure jet of liquid.

18. The process of claim 16, wherein said fluid pressure differential comprises an applied vacuum.

19. The process of claim 16, wherein said apertures include a plurality of protrusions.

20. An apertured three-dimensional sheet material, said sheet material being made by the process of claim 16.
